(19) United States
(12) Patent Application Publication
(10) Pub. No.: US 2023/0064439 A1
(43) Pub. Date: Mar. 2, 2023

(54) SWITCHING CONVERTER

(71) Applicant: Mitsubishi Electric Corporation, Tokyo (JP)

(72) Inventors: Takamasa MIURA, Tokyo (JP); Takuto YAMASHITA, Tokyo (JP)

(21) Appl. No.: 17/793,700

(22) PCT Filed: Feb. 5, 2020
(86) PCT No.: PCT/JP2020/004409

§ 371 Date: Jul. 19, 2022

(51) Int. Cl. H02M 7/219; H02M 1/34

(52) U.S. Cl. CPC H02M 7/219; H02M 1/348

(57) ABSTRACT

A switching converter includes: a reactor having one end to be connected to an AC power source; and a rectifier circuit connected to an opposite end of the reactor, the rectifier circuit converting a power source voltage applied by the AC power source into a DC voltage. The rectifier circuit includes a first leg and a second leg connected in parallel to the first leg. The first leg includes a first upper-arm element and a first lower-arm element connected in series. The second leg includes a second upper-arm element and a second lower-arm element connected in series. A snubber circuit including a resistor and a capacitor is connected to each of upper and lower-arm elements in one of the first and second legs. No snubber circuit is connected to upper and lower-arm elements in another of the first and second legs.

### CROSS REFERENCE TO RELATED APPLICATION

This application is a U.S. national stage application of International Patent Application No. PCT/JP2020/004409 filed on Feb. 5, 2020, the disclosure of which is incorporated herein by reference.

### FIELD

The present disclosure relates to a switching converter that converts an alternating-current (AC) voltage into a direct-current (DC) voltage.

### BACKGROUND

Patent Literature 1 below discloses a switching converter configured such that an AC power source is connected, via a reactor, to a connecting point between a first diode and a second diode and to a connecting point between a first metal-oxide-semiconductor field-effect transistor (MOSFET) and a second MOSFET. The first diode and the first MOSFET are upper-arm elements connected to the positive side of a smoothing capacitor, and the second diode and the second MOSFET are lower-arm elements connected to the negative side of the smoothing capacitor. The first and second diodes and the first and second MOSFETs are bridge-connected to form a rectifier circuit.

In the technique of Patent Literature 1, the first MOSFET is turned on at timing when current flows through a parasitic diode of the first MOSFET, and the second MOSFET is turned on at timing when current flows through a parasitic diode of the second MOSFET. This technique is called synchronous rectification. Synchronous rectification enables highly efficient control of a DC power-supply device.

In addition, Patent Literature 1 discloses a configuration including a short circuit that is on the input side of a rectifier and is connected in parallel to the rectifier so as to short-circuit the output of the AC power source via the reactor. A short-circuit switching element is connected to the short circuit, and when the short-circuit switching element is turned on, the output of the AC power source is short-circuited by the short circuit. This allows the switching converter to improve the power factor while performing synchronous rectification.

### PATENT LITERATURE

Patent Literature 1: Japanese Patent Application Laid-open No. 2011-151984

However, the technique of Patent Literature 1 requires the short-circuit switching element and the short circuit separately from the rectifier circuit so as to improve the power factor. Therefore, there is a problem in that the number of components increases and the device becomes expensive.

In addition, in the technique of Patent Literature 1, the short circuit is operated only once in a half period, so that improvement of the power factor is by no means sufficient.

Furthermore, in the configuration of Patent Literature 1, it is also conceivable that the number of times the first and second MOSFETs are switched will be increased so as to improve the power factor. However, an increase in the number of times switching is performed will increase an overvoltage surge that occurs at the time of switching and electro-magnetic compatibility (EMC) noise that is generated at the time of switching. Therefore, in order to increase the number of times switching is performed, some measures against noise are required. Patent Literature 1 does not mention countermeasures against an overvoltage surge and EMC noise.

### SUMMARY

The present disclosure has been made in view of the above, and an object of the present disclosure is to obtain a switching converter capable of improving efficiency by means of synchronous rectification, improving the power factor, and reducing an overvoltage surge and EMC noise while reducing the number of components.

In order to solve the above-described problems and achieve the object, a switching converter according to the present disclosure includes: a reactor having one end to be connected to an alternating-current power source; and a rectifier circuit connected to an opposite end of the reactor, the rectifier circuit converting a power source voltage into a direct-current voltage, the power source voltage being applied by the alternating-current power source. The rectifier circuit includes a first leg and a second leg, the second leg being connected in parallel to the first leg. The first leg includes a first upper-arm element and a first lower-arm element connected in series, and the second leg includes a second upper-arm element and a second lower-arm element connected in series. A snubber circuit is connected to each of upper and lower-arm elements in one of the first and second legs, the snubber circuit including a resistor and a capacitor. In contrast, the snubber circuit is connected to neither of upper and lower-arm elements in another of the first and second legs.

The switching converter according to the present disclosure has the effect of enabling improvement in efficiency by means of synchronous rectification, improvement in the power factor, and reduction in an overvoltage surge and EMC noise while reducing the number of components.

### BRIEF DESCRIPTION OF DRAWINGS

FIG. 1 is a diagram illustrating an exemplary configuration of a switching converter according to an embodiment.

FIG. 2 is a diagram illustrating another example of a snubber circuit in the embodiment.

FIG. 3 is a diagram illustrating operation waveforms of a main part of the switching converter according to the embodiment.

FIG. 4 is a first diagram illustrating a path of current flowing through a rectifier circuit in the embodiment.

FIG. 5 is a second diagram illustrating a path of current flowing through the rectifier circuit in the embodiment.

FIG. 6 is a third diagram illustrating a path of current flowing through the rectifier circuit in the embodiment.

FIG. 7 is a fourth diagram illustrating a path of current flowing through the rectifier circuit in the embodiment.

FIG. 8 is a diagram to be used to describe a transient phenomenon that may occur in a general semiconductor switching element.

FIG. 9 is a first diagram illustrating a current flow to be generated when a transient phenomenon occurs in a semiconductor switching element in the embodiment.

FIG. 10 is a second diagram illustrating a current flow to be generated when a transient phenomenon occurs in the semiconductor switching element in the embodiment.

FIG. 11 is a diagram illustrating an exemplary configuration of a switching converter according to a modification of the embodiment.

FIG. 12 is a first diagram illustrating a path of current flowing through a rectifier circuit in the modification of the embodiment.

FIG. 13 is a second diagram illustrating a path of current flowing through the rectifier circuit in the modification of the embodiment.

FIG. 14 is a third diagram illustrating a path of current flowing through the rectifier circuit in the modification of the embodiment.

FIG. 15 is a fourth diagram illustrating a path of current flowing through the rectifier circuit in the modification of the embodiment.

### DESCRIPTION OF EMBODIMENTS

### Embodiment

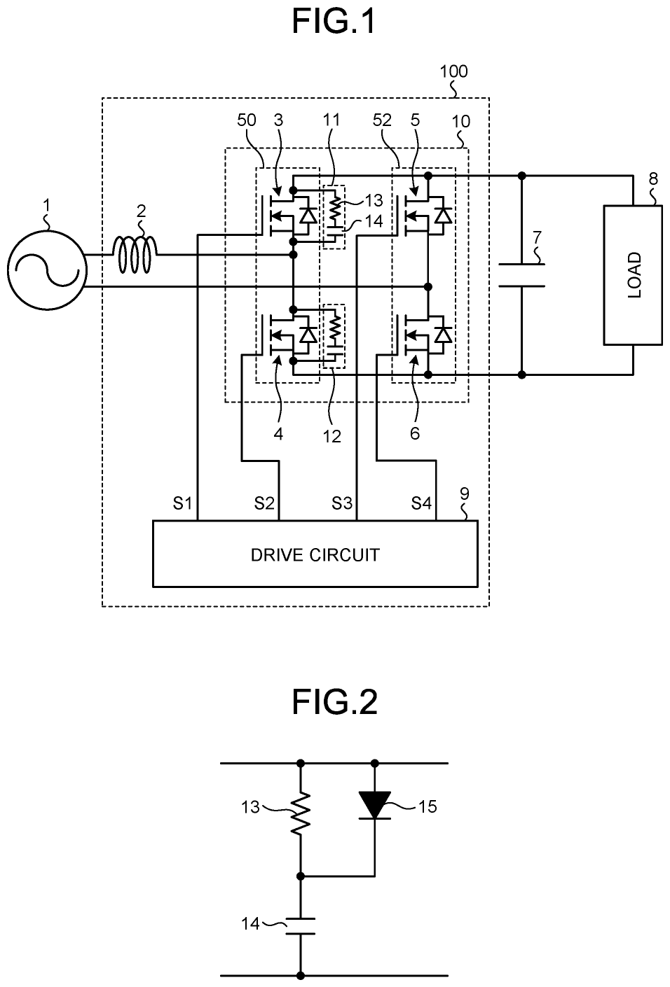

FIG. 1 is a diagram illustrating an exemplary configuration of a switching converter according to an embodiment. As illustrated in FIG. 1, a switching converter 100 according to the embodiment includes a smoothing reactor 2, a drive circuit 9, and a rectifier circuit 10. One end of the reactor 2 is connected to one side of an AC power source 1, and the opposite end of the reactor 2 is connected to one of the input ends of the rectifier circuit 10. Another input end of the rectifier circuit 10 is connected to the other side of the AC power source 1.

The rectifier circuit 10 includes a first leg 50 and a second leg 52. The second leg 52 is connected in parallel to the first leg 50. The first leg 50 includes a semiconductor switching element 3 and a semiconductor switching element 4. The semiconductor switching element 3 is a first upper-arm element. The semiconductor switching element 4 is a first lower-arm element. The semiconductor switching element 3 and the semiconductor switching element 4 are connected in series. The second leg 52 includes a semiconductor switching element 5 and a semiconductor switching element 6. The semiconductor switching element 5 is a second upper-arm element. The semiconductor switching element 6 is a second lower-arm element. The semiconductor switching element 5 and the semiconductor switching element 6 are connected in series.

In addition, the rectifier circuit 10 includes snubber circuits 11 and 12. The snubber circuits 11 and 12 are circuits each including a resistor 13 and a capacitor 14. The snubber circuit 11 is connected across the semiconductor switching element 3, and the snubber circuit 12 is connected across the semiconductor switching element 4. Meanwhile, no snubber circuit is connected to the semiconductor switching elements 5 and 6. The reason why no snubber circuit is connected to the semiconductor switching elements 5 and 6 will be described later.

FIG. 1 illustrates, as an example, a configuration in which the resistor 13 and the capacitor 14 are connected in series, but the configuration of the snubber circuit is not limited thereto. FIG. 2 is a diagram illustrating another example of the snubber circuit in the embodiment. The snubber circuit may include a diode 15 connected in parallel across the resistor 13 as illustrated in FIG. 2. Note that the circuit configuration of FIG. 2 is also an example, and several variations are known in which the resistor 13, the capacitor 14, and the diode 15, which are circuit elements, are combined in series or in parallel. That is, the snubber circuit may include a series circuit including a resistor and a capacitor, or include a circuit in which a resistor, a capacitor, and a diode are combined in series or in parallel.

The illustrated MOS-FETs are examples of the semiconductor switching elements 3, 4, 5, and 6. Note that as will be described later, the semiconductor switching elements 5 and 6 may be replaced with well-known diodes. In addition, a diode may be added in such a way as to be connected in parallel to each of the semiconductor switching elements 3, 4, 5, and 6. When MOS-FETs are used for the semiconductor switching elements 3, 4, 5, and 6, parasitic diodes are present inside the elements. Thus, the semiconductor switching elements 3, 4, 5, and 6 function as diodes in an off state.

A smoothing capacitor 7 is located between and connected to output ends of the rectifier circuit 10. The smoothing capacitor 7 is charged by the output of the rectifier circuit 10. Hereinafter, this operation is referred to as “charging operation” as appropriate. The smoothing capacitor 7 smooths a DC voltage output from the rectifier circuit 10. A load 8 is connected across the smoothing capacitor 7. The load 8 includes an inverter that operates by using power of the smoothing capacitor 7, a motor to be driven by the inverter, and a device to be driven by the motor.

The drive circuit 9 generates and outputs drive signals S1, S2, S3, and S4. The drive signal S1 is a signal for controlling conduction of the semiconductor switching element 3. The drive signal S2 is a signal for controlling conduction of the semiconductor switching element 4. The drive signal S3 is a signal for controlling conduction of the semiconductor switching element 5. The drive signal S4 is a signal for controlling conduction of the semiconductor switching element 6. When the semiconductor switching elements 3, 4, 5, and 6 are driven, the drive signals S1, S2, S3, and S4 are output after being converted to have voltage levels that enable the semiconductor switching elements 3, 4, 5, and 6 to be driven. The drive circuit 9 is implemented by use of a level-shift circuit or the like.

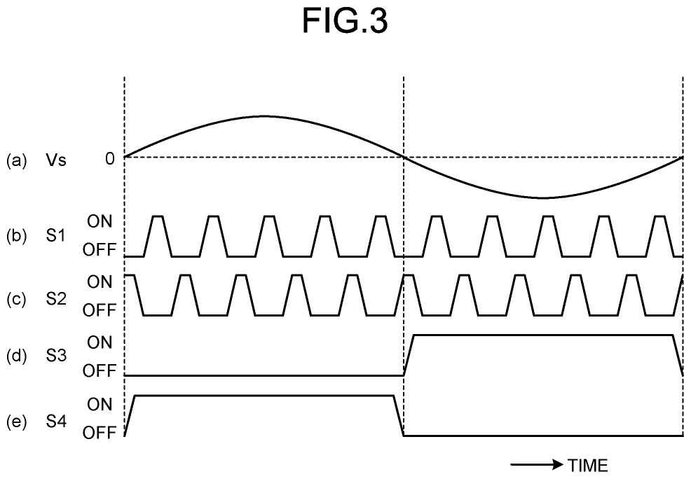

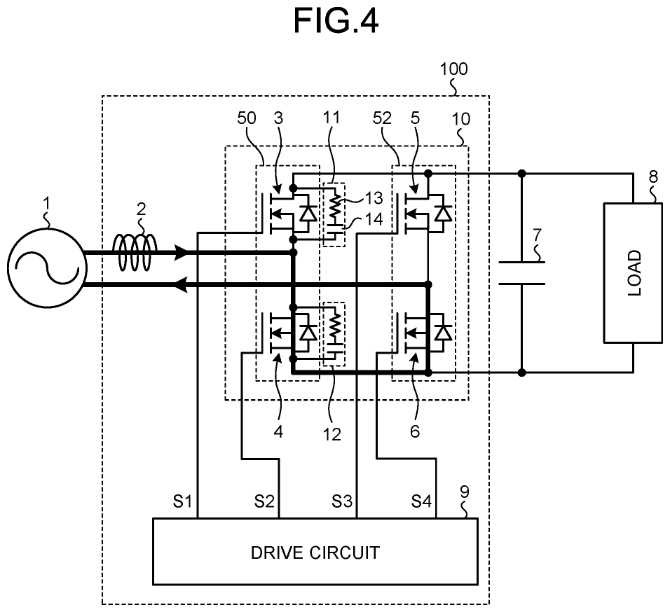

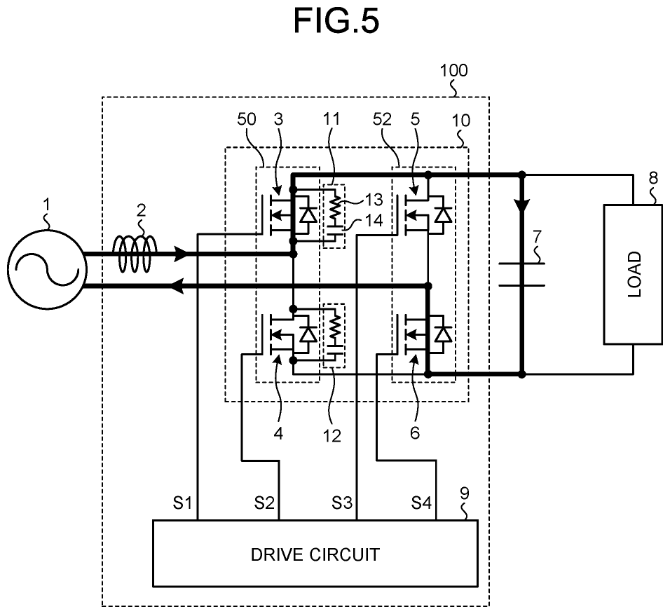

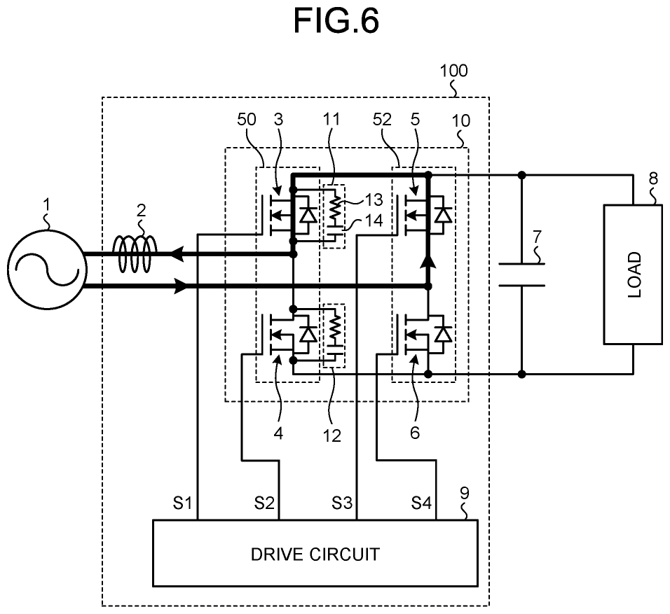

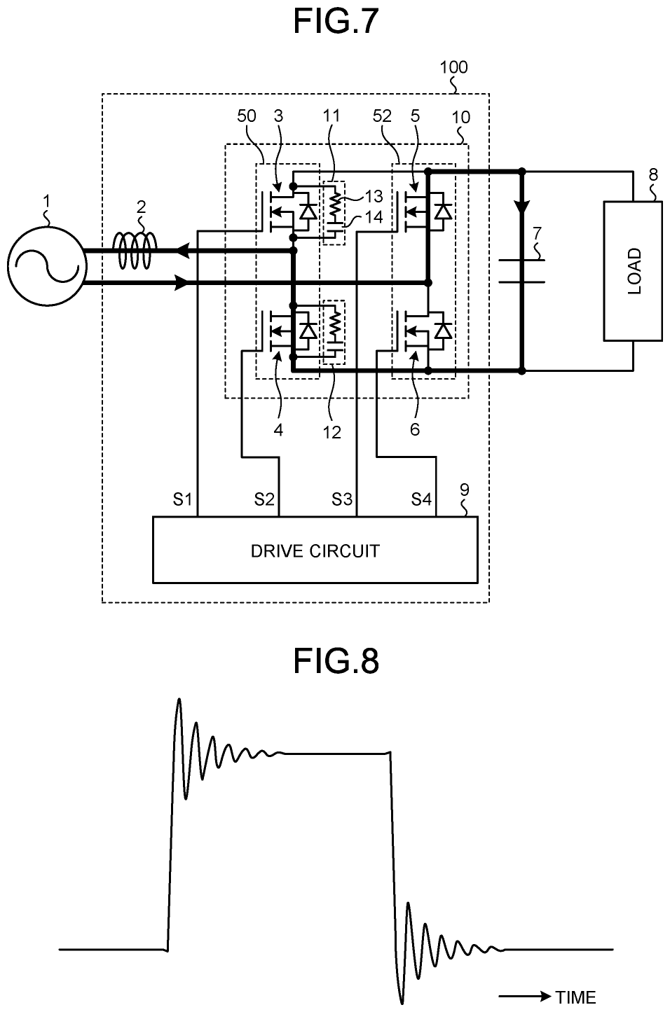

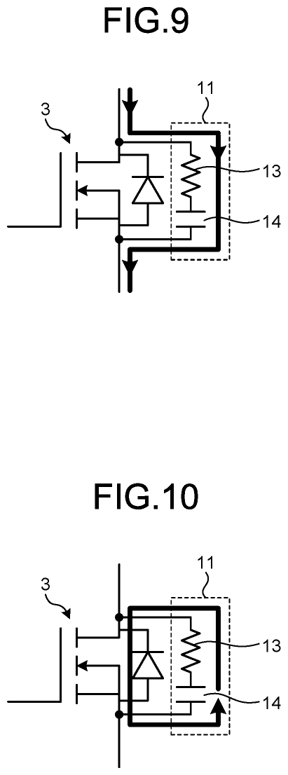

Next, operation of the switching converter according to the embodiment will be described with reference to FIGS. 3 to 10. FIG. 3 is a diagram illustrating operation waveforms of a main part of the switching converter according to the embodiment. FIG. 4 is a first diagram illustrating a path of current flowing through the rectifier circuit in the embodiment. FIG. 5 is a second diagram illustrating a path of current flowing through the rectifier circuit in the embodiment. FIG. 6 is a third diagram illustrating a path of current flowing through the rectifier circuit in the embodiment. FIG. 7 is a fourth diagram illustrating a path of current flowing through the rectifier circuit in the embodiment. FIG. 8 is a diagram to be used to describe a transient phenomenon that may occur in a general semiconductor switching element. FIG. 9 is a first diagram illustrating a current flow to be generated when a transient phenomenon occurs in the semiconductor switching element in the embodiment. FIG. 10 is a second diagram illustrating a current flow to be generated when a transient phenomenon occurs in the semiconductor switching element in the embodiment. Note that the following description is based on the assumption that the semiconductor switching elements 3, 4, 5, and 6 are MOS-FETs.

FIG. 3(a) illustrates a waveform of a power source voltage Vs to be output from the AC power source 1. The polarity of the power source voltage Vs is defined as positive when potential is higher on a side connected to the reactor 2 than on a side not connected to the reactor 2. FIG. 3(b) illustrates the drive signal S1 for driving the semiconductor switching element 3. FIG. 3(c) illustrates the drive signal S2 for driving the semiconductor switching element 4. FIG. 3(d) illustrates the drive signal S3 for driving the semiconductor switching element 5. FIG. 3(e) illustrates the drive signal S4 for driving the semiconductor switching element 6.

The semiconductor switching elements 5 and 6 are controlled with the above-described technique called synchronous rectification. Specifically, a voltage for turning on the semiconductor switching element 5 is applied between the gate and source of the semiconductor switching element 5 at timing when current flows through a parasitic diode of the semiconductor switching element 5. In addition, a voltage for turning on the semiconductor switching element 6 is applied between the gate and source of the semiconductor switching element 6 at timing when current flows through a parasitic diode of the semiconductor switching element 6.

FIGS. 4 and 5 show examples of cases where the power source voltage Vs has positive polarity. A half period on the left side of FIG. 3 corresponds to these cases, where the semiconductor switching element 6 is turned on and the semiconductor switching element 5 is turned off. FIGS. 6 and 7 show examples of cases where the power source voltage Vs has negative polarity. A half period on the right side of FIG. 3 corresponds to these cases, where the semiconductor switching element 5 is turned on and the semiconductor switching element 6 is turned off. Note that, in the following description, the period of the power source voltage Vs may be referred to as a “power source period”.

In the case of the current path illustrated in FIG. 4, the semiconductor switching elements 4 and 6 are in an on state. Thus, the power source voltage Vs is short-circuited via the reactor 2, the semiconductor switching element 4, and the semiconductor switching element 6. This operation is referred to as “power supply short circuit” or “power supply short-circuit operation” as appropriate. Energy is accumulated in the reactor 2 due to the power supply short circuit. Thereafter, the semiconductor switching element 4 is turned off and the semiconductor switching element 3 is turned on while the semiconductor switching element 6 is kept in an on state. That is, when the operation of the semiconductor switching elements 3 and 4 is reversed while the semiconductor switching element 6 is kept in an on state, the power supply short circuit is released, or removed, and current flows through the path illustrated in FIG. 5 to charge the smoothing capacitor 7. That is, when the power supply short circuit is released after energy is accumulated, the energy accumulated in the reactor 2 is transferred to and accumulated in the smoothing capacitor 7. At this time, a voltage obtained by addition of the power source voltage Vs and a voltage generated in the reactor 2 is applied to the smoothing capacitor 7. As a result, a capacitor voltage that is a voltage held in the smoothing capacitor 7 can be boosted.

Furthermore, in the case of the current path illustrated in FIG. 6, since the semiconductor switching elements 3 and 5 are in an on state, the power source voltage Vs is short-circuited via the semiconductor switching element 5, the semiconductor switching element 3, and the reactor 2. Energy is accumulated in the reactor 2 due to this power supply short circuit. Thereafter, while the semiconductor switching element 5 is kept in an on state, the semiconductor switching element 3 is turned off, and the semiconductor switching element 4 is turned on. That is, when the operation of the semiconductor switching elements 3 and 4 is reversed while the semiconductor switching element 5 is kept in an on state, the power supply short circuit is released, and current flows through the path illustrated in FIG. 7 to charge the smoothing capacitor 7. At this time, a voltage obtained by addition of the power source voltage Vs and a voltage generated in the reactor 2 is applied to the smoothing capacitor 7. As a result, the capacitor voltage can be boosted as in the case where the power source voltage Vs has positive polarity.

The semiconductor switching elements 3 and 4 alternately perform switching at any desired timing regardless of the polarity of the power source voltage Vs. It is possible to boost the power source voltage Vs by performing the power supply short-circuit operation and the charging operation a desired number of times. In addition, it is possible to improve the power factor of the AC power source 1 by performing the switching operation of the semiconductor switching elements 3 and 4 over a single period of the power source voltage Vs. Note that this operation, that is, performing the switching operation of the semiconductor switching elements 3 and 4 over a single period of the power source voltage Vs is referred to as “entire period switching” as appropriate.

In the semiconductor switching elements 3 and 4, a direction in which a voltage generated by the AC power source 1 is applied does not necessarily coincide with the direction of conduction in parasitic diodes of the semiconductor switching elements 3 and 4. Thus, the semiconductor switching elements 3 and 4 cannot be replaced with diodes.

Meanwhile, the semiconductor switching elements 5 and 6 perform rectifying operation in accordance with the polarity of the power source voltage Vs. Thus, the semiconductor switching elements 5 and 6 can be replaced with diodes in terms of the functions of charging and boosting the smoothing capacitor 7. However, in the switching converter 100 of the present embodiment, the semiconductor switching elements 5 and 6 are not replaced with diodes. The semiconductor switching elements 5 and 6 are provided without being replaced with diodes so as to enable synchronous rectification to be applied so that conduction loss in the rectifier circuit 10 is reduced.

In general, when a semiconductor switching element is turned on or off, a transient phenomenon of voltage occurs between the drain and source of the semiconductor switching element. This transient phenomenon is generally referred to as “ringing”. FIG. 8 shows an example of a ringing waveform. In FIG. 8, the horizontal axis represents time, and the vertical axis represents drain-source voltage.

The ringing causes an overvoltage surge and EMC noise described above. An increase in the switching frequency of a semiconductor switching element enhances the effect of improving the power factor, but also increases the generation amounts of the overvoltage surge and the EMC noise. The switching frequency is the number of times switching is performed in a single period or half period of the power source voltage Vs.

The magnitude of the overvoltage surge affects the withstand voltage of the semiconductor switching element. Thus, when the magnitude of the overvoltage surge increases, it is necessary to select a semiconductor switching element having a high withstand voltage, leading to an increase in cost. Meanwhile, the amount of EMC noise generation is limited by laws and standards. The EMC noise may propagate not only in a conductor but also in space. Thus, due to generation of the EMC noise, there is a risk of causing a deterioration of a communication environment and a malfunction of an integrated circuit around the switching converter 100. A conventional switching converter has been operated with a limited switching frequency to perform one-time switching of causing a short circuit once in half of the power source period or perform multiple-time switching of causing a short circuit a small number of times in half of the power source period, under conditions of an overvoltage surge equal to or less than a withstand voltage in a semiconductor switching element and an EMC noise generation amount.

In contrast, in the present embodiment, the semiconductor switching element 3 is provided with the snubber circuit 11. When the semiconductor switching element 3 is turned off, the drain-source voltage of the semiconductor switching element 3 sharply increases from zero. This voltage causes a charge to be stored in the capacitor 14 in the snubber circuit 11. FIG. 9 illustrates a current flow to be generated at this time. This current is attenuated by the resistor 13 in the snubber circuit 11. Thus, ringing occurring in the semiconductor switching element 3 is reduced. As a result, an overvoltage surge and EMC noise in the semiconductor switching element 3 can be reduced.

When the semiconductor switching element 3 is turned on, the drain-source voltage of the semiconductor switching element 3 sharply decreases to zero. At this time, the charge stored in the capacitor 14 in the snubber circuit 11 is discharged via the semiconductor switching element 3. FIG. 10 illustrates a current flow to be generated at this time. This current is attenuated by the resistor 13 in the snubber circuit 11. Thus, ringing occurring in the semiconductor switching element 3 is reduced. As a result, even when the semiconductor switching element 3 is turned on, an overvoltage surge and EMC noise in the semiconductor switching element 3 can be reduced.

As described above, the presence of the snubber circuit 11 allows the semiconductor switching element 3 to be protected from an overvoltage surge. In addition, EMC noise can be reduced to a specification value or less. Furthermore, similarly, the presence of the snubber circuit 12 allows the semiconductor switching element 4 to be protected from an overvoltage surge and allows EMC noise to be reduced to a specification value or less.

Moreover, as illustrated in FIGS. 3(d) and 3(e), the semiconductor switching elements 5 and 6 are turned on or off only once in a half period of the power source voltage Vs. Accordingly, in the semiconductor switching elements 5 and 6, ringing occurs less frequently, so that a snubber circuit is less effective. Thus, in the switching converter 100 according to the embodiment, no snubber circuit is provided for the semiconductor switching elements 5 and 6 on purpose. It is possible to reduce the number of components by providing the snubber circuits 11 and 12 only for the semiconductor switching elements 3 and 4, respectively. As a result, it is possible to achieve reduction of an overvoltage surge and EMC noise while preventing an increase in the cost of the device.

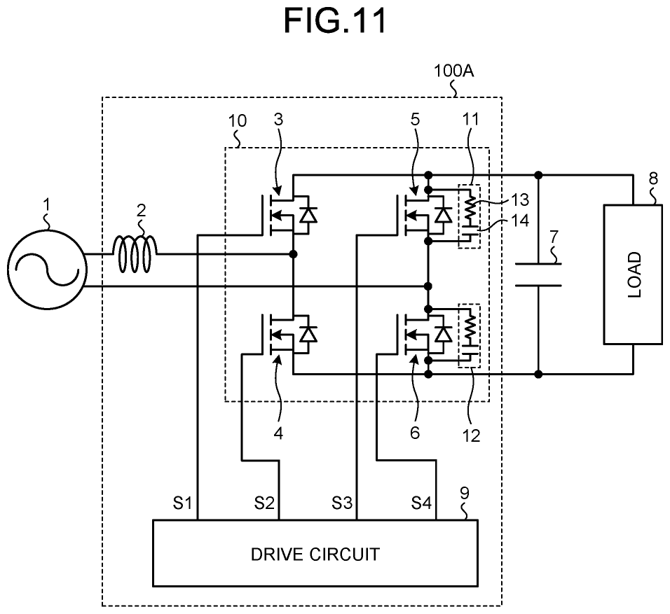

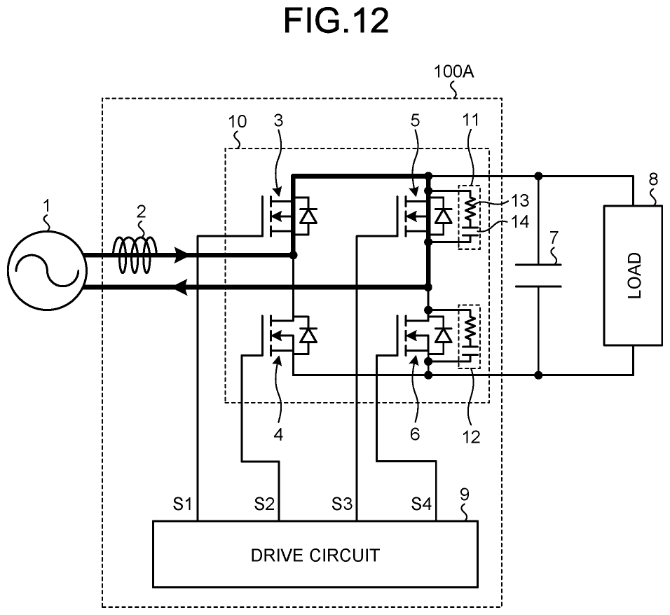

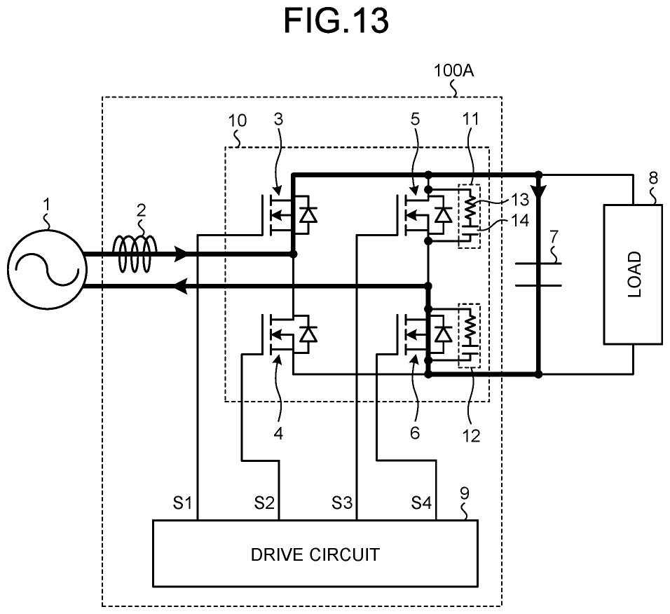

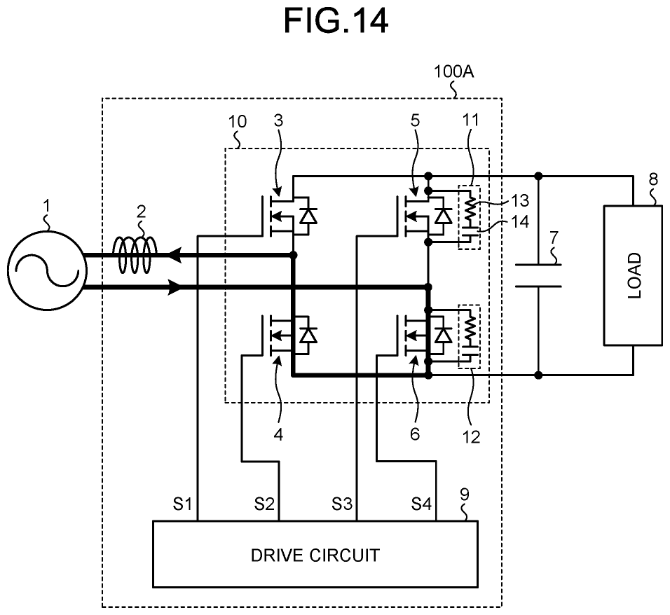

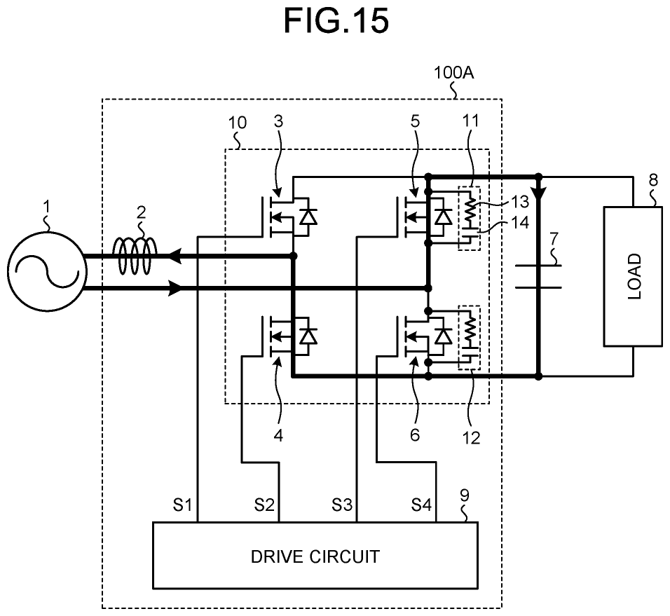

Note that, in FIG. 1, the snubber circuits 11 and 12 are provided only for the semiconductor switching elements 3 and 4, respectively, but the configuration of the switching converter according to the present disclosure is not limited to this configuration. FIG. 11 is a diagram illustrating an exemplary configuration of a switching converter according to a modification of the embodiment. As in a switching converter 100A illustrated in FIG. 11, the snubber circuits 11 and 12 may be provided only for the semiconductor switching elements 5 and 6, respectively. In the case of adopting this configuration, the above-described power supply short-circuit operation and charging operation are as illustrated in FIGS. 12 to 15. FIG. 12 is a first diagram illustrating a path of current flowing through a rectifier circuit in the modification of the embodiment. FIG. 13 is a second diagram illustrating a path of current flowing through the rectifier circuit in the modification of the embodiment. FIG. 14 is a third diagram illustrating a path of current flowing through the rectifier circuit in the modification of the embodiment. FIG. 15 is a fourth diagram illustrating a path of current flowing through the rectifier circuit in the modification of the embodiment.

In the case of the switching converter 100A according to the modification of the embodiment, the power supply short-circuit operation illustrated in FIG. 4 and the power supply short-circuit operation illustrated in FIG. 6 correspond to the power supply short-circuit operation illustrated in FIG. 12 and the power supply short-circuit operation illustrated in FIG. 14, respectively. In addition, the charging operation illustrated in FIG. 5 and the charging operation illustrated in FIG. 7 correspond to the charging operation illustrated in FIG. 13 and the charging operation illustrated in FIG. 15, respectively.

Although not illustrated, the configuration of the switching converter is not limited to the configuration in which a single reactor 2 is connected to one side of the AC power source 1 as disclosed in FIG. 1. The single reactor 2 may be connected to the other side of the AC power source 1. Furthermore, divided two reactors 2 may be connected to both of one side and the other side of the AC power source 1.

Note that semiconductor switching elements made of silicon (Si) (hereinafter referred to as “Si elements”) are generally used as switching elements used in the rectifier circuit 10 according to the present embodiment. Meanwhile, in recent years, attention has been given to semiconductor switching elements made of, instead of Si, silicon carbide (SiC) that has recently attracted attention (hereinafter referred to as “SiC elements”).

In the case of SiC elements, switching time can be significantly reduced (about 1/10 or less) as compared with conventional elements (for example, Si elements). This is a characteristic of SiC elements. Thus, switching loss is reduced. In addition, SiC elements have a low conduction loss. Therefore, loss in a steady state can also be significantly reduced (about 1/10 or less) as compared with the conventional elements.

Performing the above-described entire period switching is a characteristic of the technique according to the present embodiment. Therefore, the number of times switching is performed increases as compared with the conventional technique. Accordingly, SiC elements having a low switching loss and a low conduction loss are suitable for use in the switching converters 100 and 100A according to the present embodiment.

Note that SiC has the characteristic of having a larger bandgap than Si, and is thus regarded as an example of a semiconductor referred to as a wide bandgap semiconductor. Semiconductors formed of material other than SiC, such as gallium nitride, gallium oxide, or diamond, also belong to wide bandgap semiconductors, and such semiconductors have many characteristics similar to those of silicon carbide. Therefore, a configuration in which a wide bandgap semiconductor other than SiC is used also forms the gist of the present invention.

As described above, in the switching converter according to the embodiment, the rectifier circuit includes a first leg and a second leg that is connected in parallel to the first leg. The first leg includes a first upper-arm element and a first lower-arm element connected in series. The second leg includes a second upper-arm element and a second lower-arm element connected in series. A snubber circuit is connected to each of the upper and lower-arm elements in one of the first and second legs, the snubber circuit including a resistor and a capacitor. Meanwhile, no snubber circuit is connected to each of the upper and lower-arm elements in the other of the first and second legs. The upper and lower-arm elements to which no snubber circuits are connected are driven with a power source period, and the upper and lower-arm elements to which the snubber circuits are connected are driven with a period shorter than the power source period. Therefore, it is possible to improve efficiency by means of synchronous rectification, improve the power factor, and reduce an overvoltage surge and EMC noise while reducing the number of components.

Note that the configurations set forth in the above embodiment show examples, and it is possible to combine the configurations with another technique that is publicly known, and is also possible to omit or change part of the configurations without departing from the scope.

1. A switching converter comprising:
a reactor having one end to be connected to an alternating-current power source; and
a rectifier circuit connected to an opposite end of the reactor, the rectifier circuit converting a power source voltage into a direct-current voltage, the power source voltage being applied by the alternating-current power source, wherein
the rectifier circuit includes a first leg and a second leg, the second leg being connected in parallel to the first leg,
the first leg includes a first upper-arm element and a first lower-arm element connected in series,
the second leg includes a second upper-arm element and a second lower-arm element connected in series,
each of the first upper-arm element, the first lower-arm element, the second upper-arm element, and the second lower-arm element is a semiconductor switching element,
a snubber circuit is connected to each of upper and lower-arm elements in one of the first and second legs, the snubber circuit including a resistor and a capacitor, and
the snubber circuit is connected to neither of upper and lower-arm elements in another of the first and second legs.

2. The switching converter according to claim 1, wherein
the upper and lower-arm elements to which the snubber circuits are not connected are driven with a power source period that is a period of the power source voltage, and
the upper and lower-arm elements to which the snubber circuits are connected are driven with a period shorter than the power source period.

3. The switching converter according to claim 1 or 2, wherein
the upper and lower-arm elements in the first and second legs are formed of a wide bandgap semiconductor.

4. The switching converter according to claim 3, wherein
the wide bandgap semiconductor is silicon carbide, gallium nitride, gallium oxide, or diamond.

5. The switching converter according to claim 2, wherein
the upper and lower-arm elements in the first and second legs are formed of a wide bandgap semiconductor.

6. The switching converter according to claim 5, wherein
the wide bandgap semiconductor is silicon carbide, gallium nitride, gallium oxide, or diamond.
